(19) United States
(12) Patent Application Publication
(10) Pub. No.: US 2014/0089815 A1
(43) Pub. Date: Mar. 27, 2014

(54) Sharing Content-Synchronized Ratings

(71) Applicant: Google Inc., (US)

(72) Inventors: Andrew Gildfind, Brixton (GB); Yaroslav Volovich, Cambridge (GB); Ant Oztaskent, Surrey (GB); Simon Michael Rowe, Berkshire (GB)

(73) Assignee: Google Inc., Mountain View, CA (US)

(21) Appl. No.: 13/624,780

(22) Filed: Sep. 21, 2012

(51) Int. Cl. G06F 3/01

(52) U.S. Cl. 715/753

(57) ABSTRACT

Systems, methods and devices described herein enable sharing content-synchronized ratings, related to media content playing on a first device, using one or more second devices. For example, while a television program is playing on a television, a tablet computer acquires and sends content information derived from the video stream to a server. The server identifies the television program by matching the content information to a fingerprint. Then the server system generates a set of instructions, a time-marker, and one or more content-synchronized ratings collected from other user devices. The set of instructions includes instructions for synchronizing to the time-marker, enabling sharing of one or more content-synchronized ratings, and displaying content-synchronized ratings from other users. The set of instructions and content are sent to the tablet computer for execution and display.

### TECHNICAL FIELD

The present application describes systems and methods of sharing content-synchronized ratings of media content presented on a first device by using second devices.

### BACKGROUND

Arbitrarily broadcasting content over the Internet to other users, such as by so-called “spam” emails or the like, is generally discouraged and considered a nuisance. Acceptable Internet-based content delivery and sharing is typically structured using a publisher-follower model. According to the model, content publishers are limited to posting content to websites and are restricted from arbitrarily broadcasting content to users they do not have an established connection to. Social networking applications and blogging (e.g. micro-blogging) applications are examples of Internet-based content delivery and sharing mediums that generally adhere to the publisher-follower model.

The publisher-follower model limits how quickly and with whom users can share information. The model is based on followers seeking out publishers that publish content they are interested in. In order to share information with a wide audience, publishers must first attract followers by, for example, regularly publishing content that resonates with a particular audience and hoping that they develop followers from within that audience. But a particular user may want to express an impromptu opinion without trying to address a particular audience or without even having a well formed opinion. Constrained by the model, such causal publishers cannot readily share their opinions beyond their own social networks.

Reciprocally, it is difficult for a casual follower to determine the public or community opinion about a particular subject that is occurring in real-time, such as a television (TV) program. According to the model, users have to seek out various content publishers that post content about the subject. But it can be time consuming to decipher public or community opinion about the subject from ratings, articles and/or comments posted on websites or micro-blogging applications. For example, in the case of a TV program, the research involved may take longer than the duration of the TV program, which makes trying to determine public or community opinion about the TV program as it is happening a futile endeavor.

### SUMMARY

The aforementioned deficiencies and other problems are reduced or eliminated by the disclosed systems, methods and devices. Various implementations of systems, methods and devices within the scope of the claims each have several aspects, no single one of which is solely responsible for the desirable attributes described herein. Without limiting the scope of the claims, some prominent features of example implementations are described herein. After considering this description one will understand how the features of various implementations are configured to enable one or more users to share opinions in real-time about content being presented on a first type of device using respective Internet-enabled second devices.

More specifically, the systems, methods and devices described herein enable sharing content-synchronized ratings, related to media content playing on a first device, using one or more second devices. For example, while a video stream is playing on a first client device (e.g. a television), a second client device (e.g. a tablet computer) acquires and sends content information derived from the video stream to a server system. The server system identifies the video stream playing on the first client device by matching the content information to a content fingerprint. Then, based on the matched fingerprint, the server system generates a set of instructions, a time-marker, and one or more content-synchronized ratings collected from other user devices. The set of instructions includes instructions to synchronize a local timer maintained by the second client device to the time-marker provided by the server system, instructions enabling sharing of one or more content-synchronized ratings, and instructions to display content-synchronized ratings from other users. The set of instructions is sent to the second client device for execution and the related content is sent to the second client device for display. The second client device executes one or more applications in accordance with the set of instructions and displays the related content.

Some implementations include systems, methods and/or devices enabled to allow sharing of content-synchronized ratings related to playing media content on a first device including a processor, memory and a display, the method comprising. In some implementations, a method of allowing sharing of content-synchronized ratings includes detecting, using the first device, media content playing to a user; receiving, at the first device from a second device, a first content-synchronized rating associated with the playing media content; displaying on the display the first content-synchronized rating associated with the playing media content; displaying on the display an interface operable to receive a user input indicative of a user rating associated with the playing media; and, communicating a data structure including the user rating to the second device. In some implementations, a method of allowing sharing of content-synchronized ratings includes transmitting a time marker associated with the media content to a plurality of user devices; receiving from the plurality of user devices respective content-synchronized ratings related to media content; analyzing the content-synchronized ratings to generate a sub-set of ratings; and transmitting the sub-set of ratings to at least one of the plurality of user devices.

Some implementations include systems, methods and/or devices enabled to determine audience sentiment from content-synchronized ratings, related to media content, on a device including a processor and a memory. In some implementations, a method of determining comprises receiving from the plurality of user devices respective content-synchronized ratings related to media content; and analyzing the content-synchronized ratings to generate one or more metrics indicative of audience sentiment.

Some implementations include systems, methods and/or devices enabled to seed audience sentiment using salable ratings on a device including a processor, and a memory. In some implementations, a method of seeding audience sentiment includes transmitting a suggested set of selectable ratings associated with the media content to a plurality of user devices; and receiving from the plurality of user devices respective content-synchronized ratings related to media content.

Some implementations include systems, methods and/or devices enabled to display time-varying content synchronized ratings on a first device including a process, a memory and a display. In some implementations, a method of displaying time-varying content-synchronized ratings includes detecting, using the first device, media content playing to a user; receiving, at the first device from a second device (e.g. server), content-synchronized ratings associated with the playing media content provided by others, wherein each rating includes a data structure indicating respective characteristics of the rating; and displaying on the display the content-synchronized ratings associated with the playing media content in accordance with the respective characteristics for each rating.

### BRIEF DESCRIPTION OF THE DRAWINGS

FIG. 1 is a block diagram of a client-server environment according to some implementations.

FIG. 2 is a block diagram of a client-server environment according to some implementations.

FIG. 3A is a block diagram of a configuration of a server system according to some implementations.

FIG. 3B is a block diagram of a data structure according to some implementations.

FIG. 4A is a block diagram of a configuration of a client device according to some implementations.

FIG. 4B is a block diagram of a configuration of another client device according to some implementations.

FIG. 5 is a flowchart representation of a method according to some implementations.

FIG. 6 is a flowchart representation of a method according to some implementations.

FIG. 7 is a schematic diagram of example screenshots according to some implementations.

FIG. 8 is a flowchart representation of a method according to some implementations.

FIG. 9 is a flowchart representation of a method according to some implementations.

FIG. 10 is a flowchart representation of a method according to some implementations.

FIG. 11 is a signaling diagram representation of some of the transmissions between devices according to some implementations.

FIG. 12 is a flowchart representation of a method according to some implementations.

FIG. 13 is a flowchart representation of a method according to some implementations.

FIG. 14 is a flowchart representation of a method according to some implementations.

In accordance with common practice the various features illustrated in the drawings may not be drawn to scale. As such, the dimensions of the various features may be arbitrarily expanded or reduced for clarity. In addition, some of the drawings may not depict all of the components of a given system, method or device. Finally, like reference numerals are used to denote like features throughout the specification and drawings.

### DETAILED DESCRIPTION

Reference will now be made in detail to various implementations, examples of which are illustrated in the accompanying drawings. In the following detailed description, numerous specific details are set forth in order to provide a thorough understanding of aspects of the implementations. However, the subject matter described and claimed herein may be practiced without these specific details. In other instances, well-known methods, procedures, components, and circuits have not been described in detail so as not to unnecessarily obscure aspects of the disclosed implementations.

Systems, methods and devices described herein enable sharing content-synchronized ratings, related to media content playing on a first device, using one or more second devices. For example, while a television program is playing on a television, a tablet computer acquires and sends content information derived from the video stream to a server. The server identifies the television program by matching the content information to a fingerprint. Then the server system generates a set of instructions, a time-marker, and one or more content-synchronized ratings collected from other user devices. The set of instructions includes instructions for synchronizing to the time-marker, enabling sharing of one or more content-synchronized ratings, and displaying content-synchronized ratings from other users. The set of instructions and content are sent to the tablet computer for execution and display

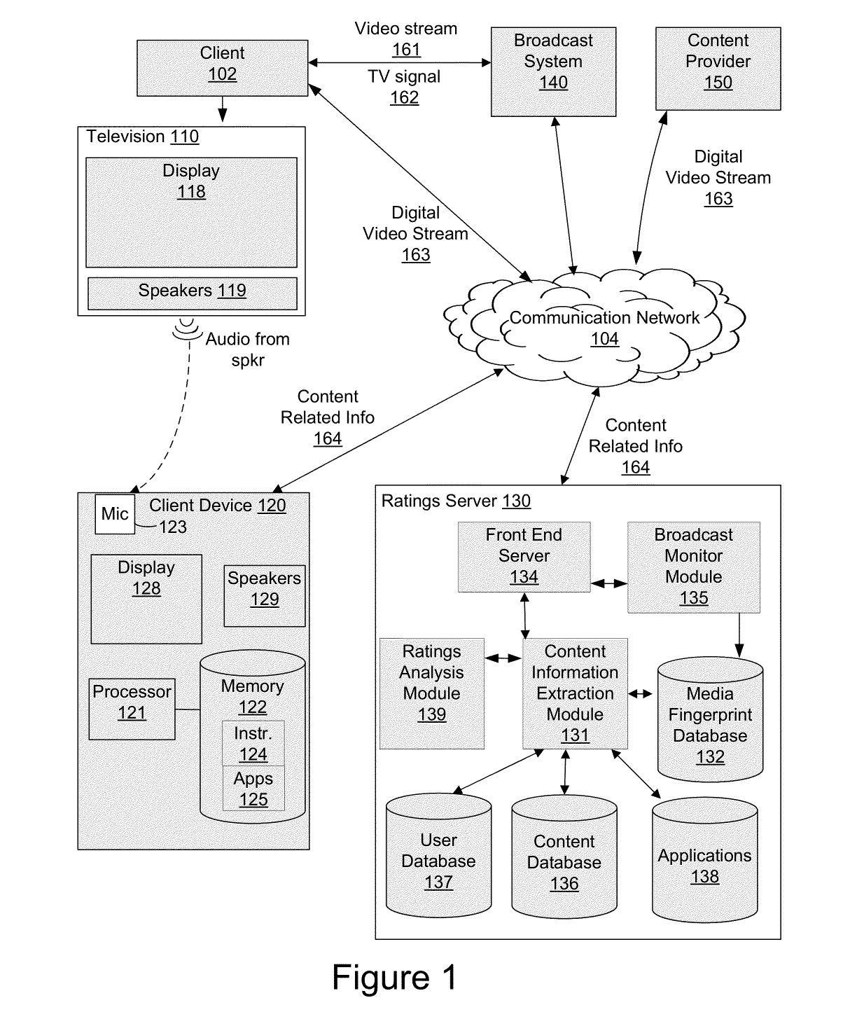

FIG. 1 is a block diagram of a simplified example client-server environment 100 according to some implementations. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 100 includes a client device 102, a television (TV) 110, a second screen client device 120, a communication network 104, a ratings server 130, a broadcast system 140, and a content provider 150. The client device 102, the second screen client device 120, the ratings server 130, the broadcast system 140, and the content provider 150 are capable of being connected to the communication network 104 in order to exchange information with one another and/or other devices and systems.

In some implementations, the ratings server 130 is implemented as a single server system, while in other implementations it is implemented as a distributed system of multiple servers. Solely for convenience of explanation, the ratings server 130 is described below as being implemented on a single server system. Similarly, in some implementations, the broadcast system 140 is implemented as a single server system, while in other implementations it is implemented as a distributed system of multiple servers. Solely, for convenience of explanation, the broadcast system 140 is described below as being implemented on a single server system. Similarly, in some implementations, the content provider 150 is implemented as a single server system, while in other implementations it is implemented as a distributed system of multiple servers. Solely, for convenience of explanation, the content provider 150 is described below as being implemented on a single server system. Moreover, the functionality of the broadcast system 140 and the content provider 150 can be combined into a single server system. Additionally and/or alternatively, while only one broadcast system and only one content provider is illustrated in FIG. 1 for the sake of brevity, those skilled in the art will appreciate from the present disclosure that fewer or more of each may be present in an implementation of a client-server environment.

The communication network 104 may be any combination of wired and wireless local area network (LAN) and/or wide area network (WAN), such as an intranet, an extranet, including a portion of the Internet. It is sufficient that the communication network 104 provides communication capability between the second screen client device 120 and the ratings server 130. In some implementations, the communication network 104 uses the HyperText Transport Protocol (HTTP) to transport information using the Transmission Control Protocol/Internet Protocol (TCP/IP). HTTP permits client devices 102 and 120 to access various resources available via the communication network 104. However, the various implementations described herein are not limited to the use of any particular protocol.

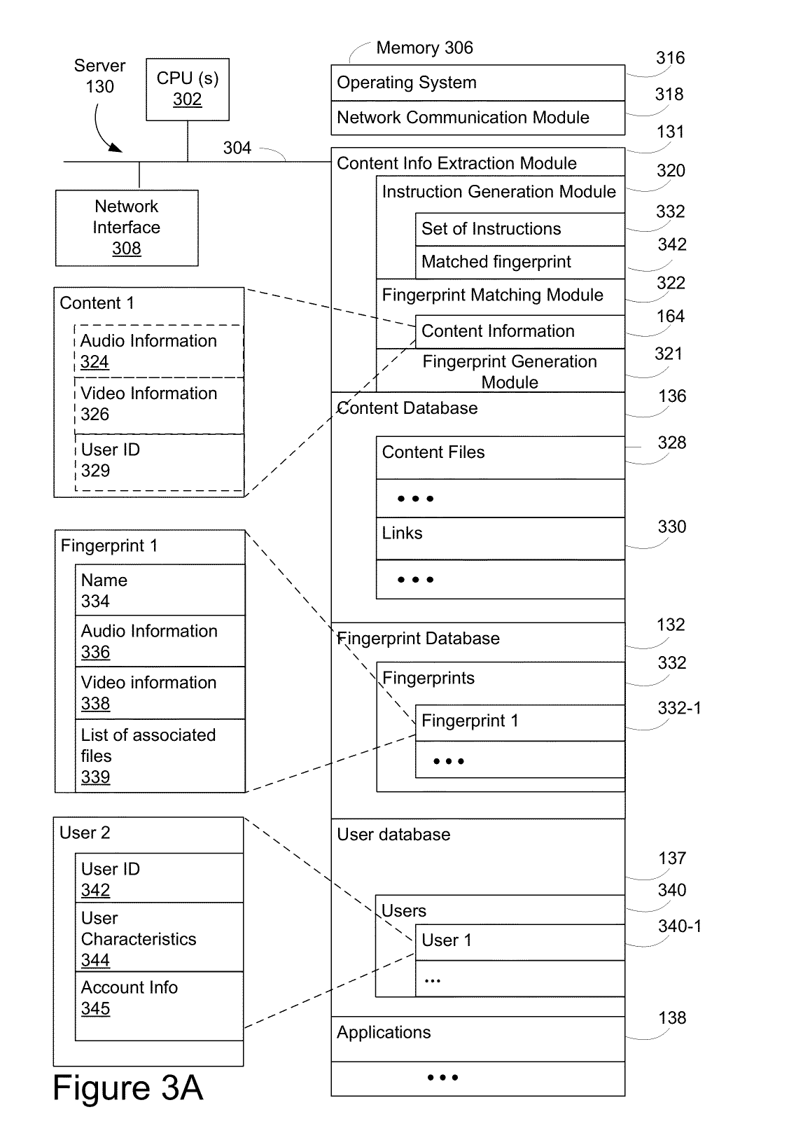

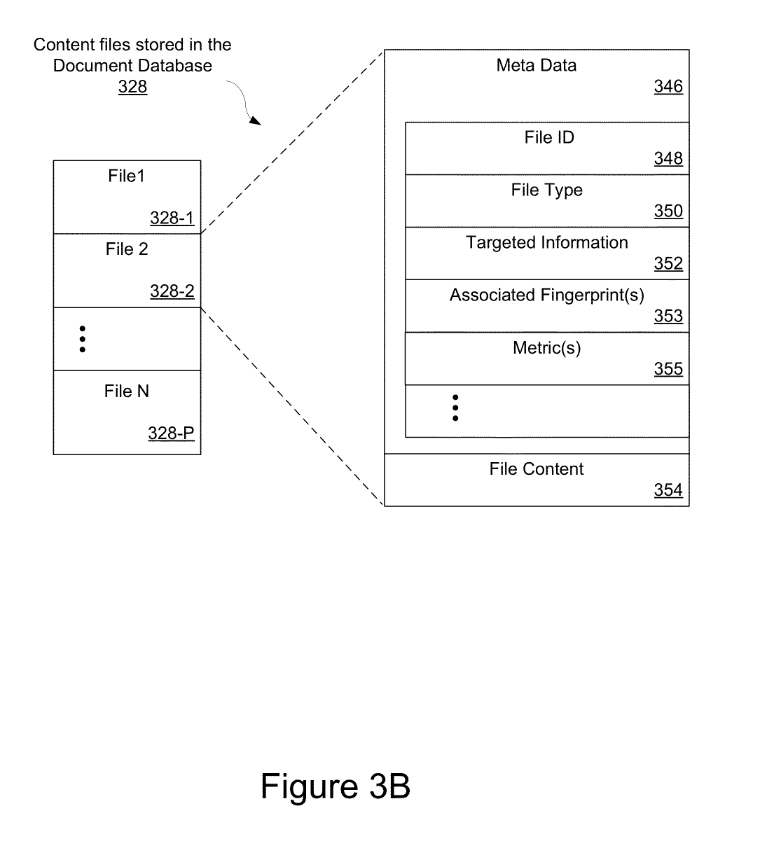

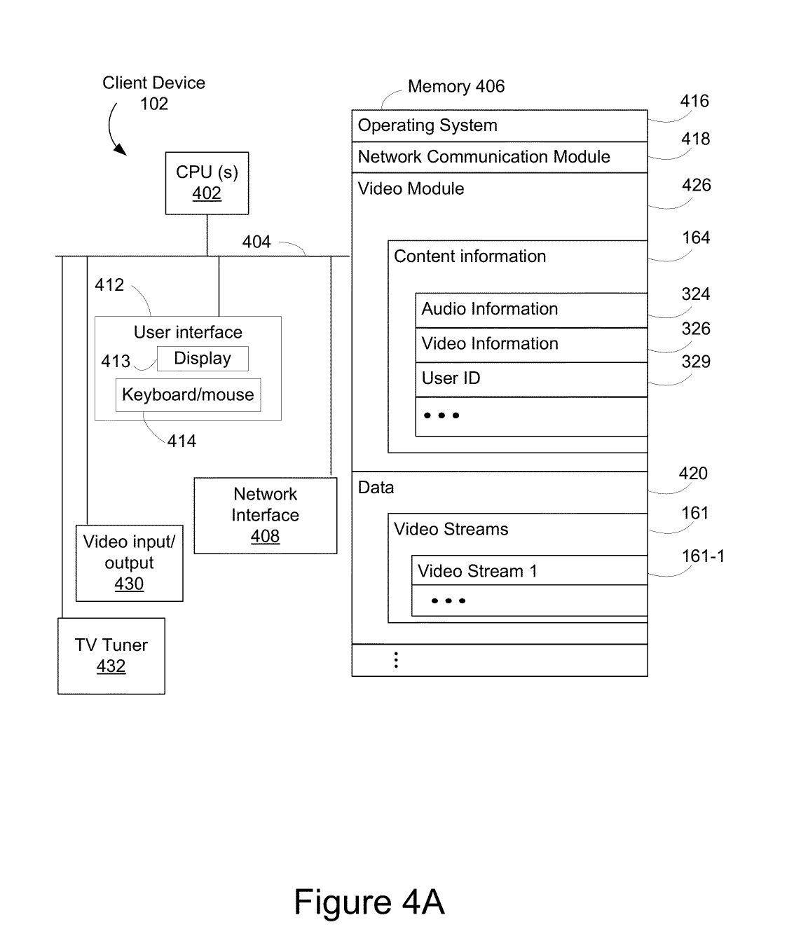

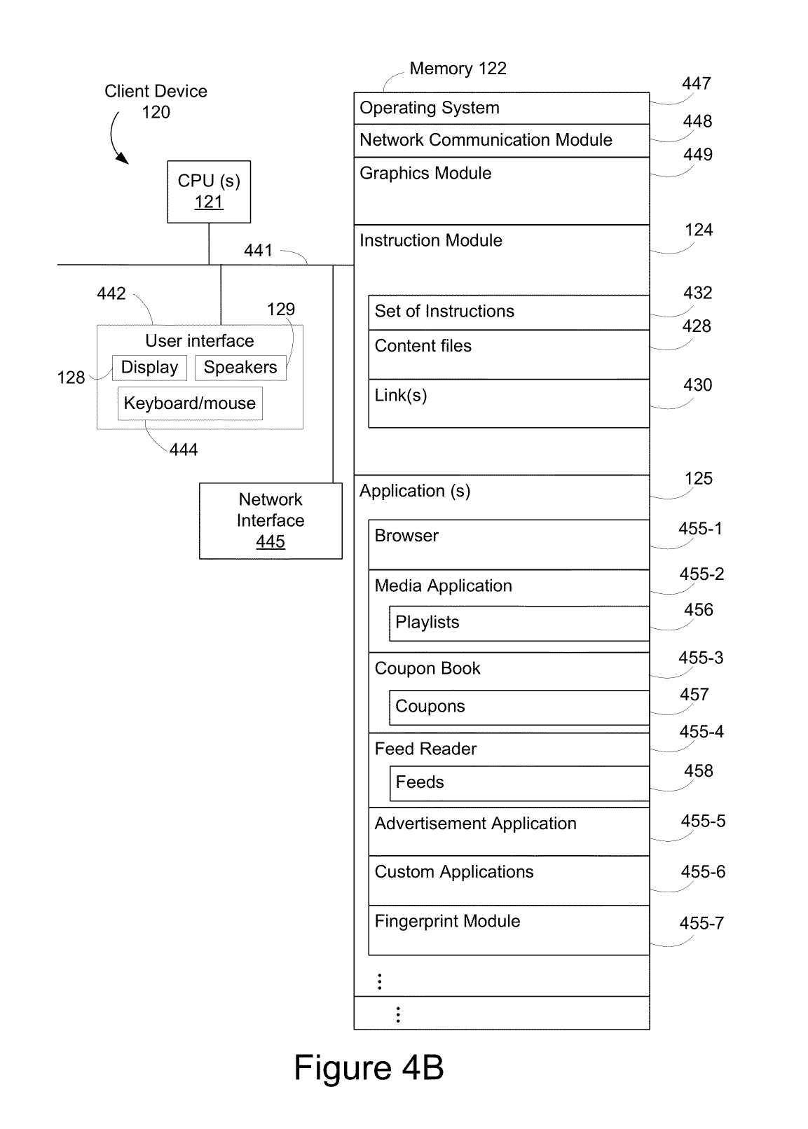

In some implementations, the ratings server 130 includes a front end server 134 that facilitates communication between the ratings server 130 and the communication network 104. The front end server 134 receives content information 164 from the second screen client device 120. As described in greater detail below with reference to FIGS. 3A-4B, in some implementations, the content information 164 is a video stream, a portion thereof, and/or a reference to a portion thereof. A reference to a portion of a video stream may include a time indicator and/or a digital marker referencing the content of the video stream. In some implementations, the content information 164 is derived from a video stream being presented (i.e. playing) by the combination of the TV 110 and the client 102.

In some implementations, the front end server 134 is configured to send a set of instructions to the second screen client device 120. In some implementations, the front end server 134 is configured to send content files and/or links to content files. The term “content file” includes any document or content of any format including, but not limited to, a video file, an image file, a music file, a web page, an email message, an SMS message, a content feed, an advertisement, a coupon, a playlist or an XML document. In some implementations, the front end server 134 is configured to send or receive one or more video streams. In some implementations, the front end server 134 is configured to receive content directly from the broadcast system 140 and/or the content provider 150 over the communication network 104.

According to some implementations, a video or video stream is a sequence of images or frames representing scenes in motion. A video can be distinguished from an image. A video displays a number of images or frames per second. For example, a video displays 30 or 60 consecutive image frames per second. In contrast, an image is not necessarily associated with any other images.

A content feed (or channel) is a resource or service that provides a list of content items that are present, recently added, or recently updated at a feed source. A content item in a content feed may include the content associated with the item itself (the actual content that the content item specifies), a title (sometimes called a headline), and/or a description of the content, a network location or locator (e.g., URL) of the content, or any combination thereof. For example, if the content item identifies a text article, the content item may include the article itself inline, along with the title (or headline), and locator. Alternatively, a content item may include the title, description and locator, but not the article content. Thus, some content items may include the content associated with those items, while others contain links to the associated content but not the full content of the items. A content item may also include additional meta data that provides additional information about the content. For example, the meta data may include a time-stamp or embedded selectable website links. The full version of the content may be any machine-readable data, including but not limited to web pages, images, digital audio, digital video, Portable Document Format (PDF) documents, and so forth.

In some implementations, a content feed is specified using a content syndication format, such as RSS. RSS is an acronym that stands for “rich site summary,” “RDF site summary,” or “Really Simple Syndication.” “RSS” may refer to any of a family of formats based on the Extensible Markup Language (XML) for specifying a content feed and content items included in the feed. In some other implementations, other content syndication formats, such as the Atom syndication format or the VCALENDAR calendar format, may be used to specify content feeds.

In some implementations, the ratings server 130 is configured to receive content information 164 from the second screen client device 120, match the content information to a content fingerprint in the fingerprint database 132, generate a set of instructions and a set of prior ratings based on the matched fingerprint and send the set of instructions and the ratings to the second screen client device 120 for execution, display and/or selection. To that end, as described in greater detail below, in some implementations the ratings server 130 includes a ratings analysis module 139 that is configured to collect, analyze and share ratings provided by a number of users. In some implementations, the ratings analysis module 139 is a distributed network of elements. In some implementations, the ratings server 130 includes a content information extraction module 131 that is configured to operate with the front end server 134 and the ratings analysis module 139 to identify (i.e. fingerprint) the playing media content and provide information about the playing media content. In some implementations, the content information extraction module 131 is a distributed network of elements.

In some implementations, the ratings server 130 includes a user database 137 that stores user data. In some implementations, the user database 137 is a distributed database. In some implementations, the ratings server 130 includes a content database 136. In some implementations, the content database 136 includes advertisements, videos, images, music, web pages, email messages, SMS messages, content feeds, advertisements, coupons, playlists, XML documents, and ratings associated with various media content or any combination thereof. In some implementations, the content database 136 includes links to advertisements, videos, images, music, web pages, email messages, SMS messages, content feeds, advertisements, coupons, playlists, XML documents and ratings associated with various media content. In some implementations, the content database 136 is a distributed database.

As noted above, in some implementations, the ratings server 130 includes a fingerprint database 132 that stores content fingerprints. A content fingerprint includes any type of condensed or compact representation, or signature, of the content of a video stream and/or audio stream. In some implementations, a fingerprint may represent a clip (such as several seconds, minutes, or hours) of a video stream or audio stream. Or, a fingerprint may represent a single instant of a video stream or audio stream (e.g., a fingerprint of single frame of a video or of the audio associated with that frame of video). Furthermore, since video content may changes over time, corresponding fingerprints of that video content may also change over time. In some implementations, the fingerprint database 132 is a distributed database.

In some implementations, the rating server system 130 includes a broadcast monitor module 135 that is configured to create fingerprints of media content broadcast by the broadcast system 140 and/or the content provider 150.

In some implementations, the client device 102 is provided in combination with a display device such as a TV 110. The client device 102 is configured to receive a video stream 161 from the broadcast system 140 and pass the video stream to the TV 110 for display. While a TV has been used in the illustrated example, those skilled in the art will appreciate from the present disclosure that any number of displays devices, including computers, laptop computers, tablet computers, smart-phones and the like, can be used to display a video stream. Additionally and/or alternatively, the functions of the client 102 and the TV 110 may be combined into a single device.

In some implementations, the client device 102 is any suitable computer device capable of connecting to the communication network 104, receiving video streams, extracting information from video streams and presenting video streams for the display using the TV 110 (or another display device). In some implementations, the client device 102 is a set top box that includes components to receive and present video streams. For example, the client device 102 can be a set top box for receiving cable TV and/or satellite TV, a digital video recorder (DVR), a digital media receiver, a TV tuner, a computer, and/or any other device that outputs TV signals. In some implementations, the client device 102 displays a video stream on the TV 110. In some implementations the TV 110 can be a conventional TV display that is not connectable to the Internet and that displays digital and/or analog TV content received via over the air broadcasts or a satellite or cable connection.

As is typical of televisions, the TV 110 includes a display 118 and speakers 119. Additionally and/or alternatively, the TV 110 can be replaced with another type of display device 108 for presenting video content to a user. For example, the display device may be a computer monitor that is configured to receive and display audio and video signals or other digital content from the client 102. In some implementations, the display device is an electronic device with a central processing unit, memory and a display that is configured to receive and display audio and video signals or other digital content form the client 102. For example, the display device can be a LCD screen, a tablet device, a mobile telephone, a projector, or other type of video display system. The display device can be coupled to the client 102 via a wireless or wired connection.

In some implementations, the client device 102 receives video streams 161 via a TV signal 162. As used herein, a TV signal is an electrical, optical, or other type of data transmitting medium that includes audio and/or video components corresponding to a TV channel. In some implementations, the TV signal 162 is a terrestrial over-the-air TV broadcast signal or a sign distributed/broadcast on a cable-system or a satellite system. In some implementations, the TV signal 162 is transmitted as data over a network connection. For example, the client device 102 can receive video streams from an Internet connection. Audio and video components of a TV signal are sometimes referred to herein as audio signals and video signals. In some implementations, a TV signal corresponds to a TV channel that is being displayed on the TV 110.

In some implementations, a TV signal 162 carries information for audible sound corresponding to an audio track on a TV channel. In some implementations, the audible sound is produced by the speakers 119 included with the TV 110.

The second screen client device 120 may be any suitable computer device that is capable of connecting to the communication network 104, such as a computer, a laptop computer, a tablet device, a netbook, an internet kiosk, a personal digital assistant, a mobile phone, a gaming device, or any other device that is capable of communicating with the ratings server 130. In some implementations, the second screen client device 120 includes one or more processors 121, non-volatile memory 122 such as a hard disk drive, a display 128, speakers 129, and a microphone 123. The second screen client device 120 may also have input devices such as a keyboard, a mouse and/or track-pad (not shown). In some implementations, the second screen client device 120 includes a touch screen display, a digital camera and/or any number of supplemental devices to add functionality.

In some implementations, the second screen client device 120 is connected to and/or includes a display device 128. The display device 128 can be any display for presenting video content to a user. In some implementations, the display device 128 is the display of a television, or a computer monitor, that is configured to receive and display audio and video signals or other digital content from the second screen client device 120. In some implementations, the display device 128 is an electronic device with a central processing unit 121, memory 122 and a display that is configured to receive and display audio and video signals or other digital content. In some implementations, the display device 128 is a LCD screen, a tablet device, a mobile telephone, a projector, or any other type of video display system. In some implementations, the second screen client device 120 is connected to and/or integrated with the display device 128. In some implementations, the display device 128 includes, or is otherwise connected to, speakers capable of producing an audible stream corresponding to the audio component of a TV signal or video stream.

In some implementations, the second screen client device 120 is connected to the client device 102 via a wireless or wired connection 103. In some implementations where such connection exists, the second screen client device 120 may optionally operate in accordance with instructions, information and/or digital content (collectively “second screen information”) provided by the client device 102. In some implementations, the client device 102 issues instructions to the second screen client device 120 that cause the second screen client device 120 to present on the display 128 and/or the speaker 129 digital content that is complementary, or related to, digital content that is being presented by the client 102 on the TV 110.

In some implementations, the second screen client device 120 includes a microphone 123 that enables the client device to receive sound (audio content) from, for example, the speakers 119 of the TV 110. The microphone 123 enables the second screen client device 120 to store the audio content/soundtrack that is associated with the video content as it is presented. The second screen client device 120 can store this information locally and then send to the ratings server 130 content information 164 that is any one or more of: fingerprints of the stored audio content, the audio content itself, portions/snippets of the audio content, fingerprints of the portions of the audio content or references to the playing content.

In this way, the ratings server 130 can identify the content playing on the television even if the electronic device on which the content is being presented is not an Internet-enabled device, such as an older TV set; is not connected to the Internet (temporarily or permanently) so is unable to send the content information 164; or does not have the capability to record or fingerprint media information related to the video content. Such an arrangement (i.e., where the second screen client device 120 stores and sends the content information 164 to the ratings server 130) allows a user to receive from the ratings server 130 second screen content triggered in response to the content information 164 no matter where the user is watching TV.

In some implementations, the second screen client device 120 includes one or more applications 125 stored in the memory 122. As discussed in greater detail below, the processor 121 executes the one or more applications in accordance with a set of instructions received from the ratings server 130.

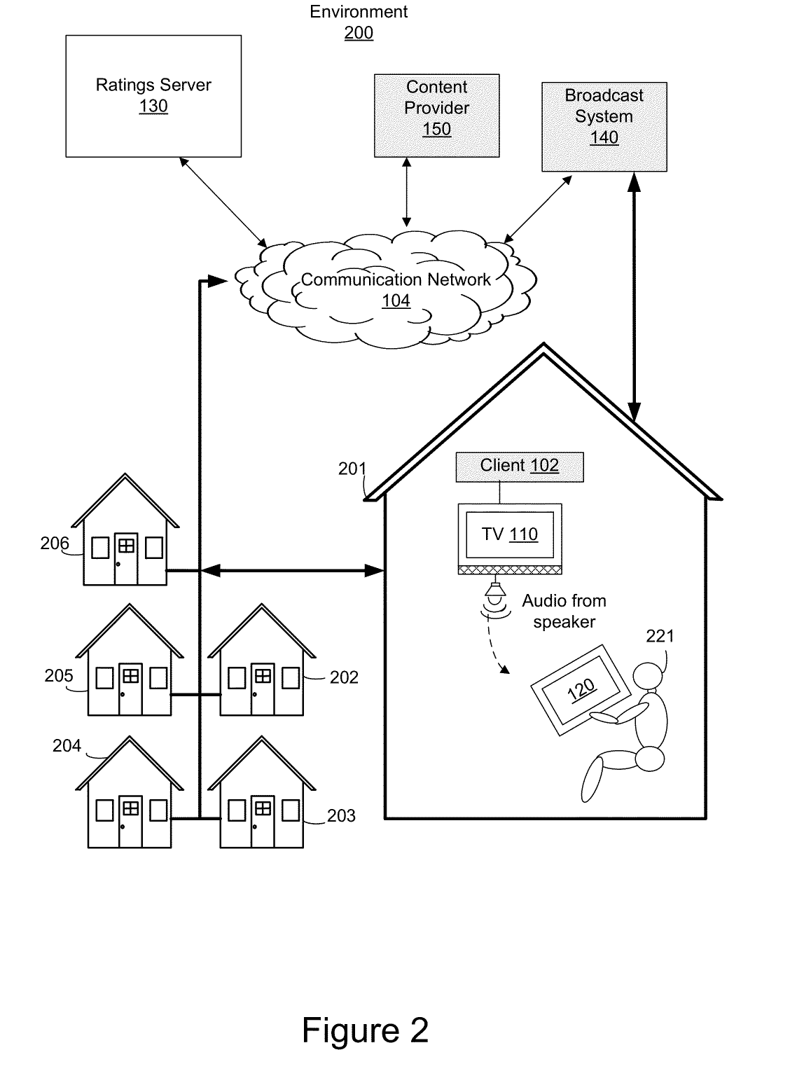

FIG. 2 is a block diagram of a client-server environment 200 according to some implementations. The client-server environment 200 illustrated in FIG. 2 is similar to and adapted from the client-server environment 100 illustrated in FIG. 1. Elements common to both share common reference indicia, and only the differences between the client-server environments 100, 200 are described herein for the sake of brevity.

As a non-limiting example, within the client-server environment 200, the client 102, the TV 110 and second screen client device 120 are included in a first residential location 201. In operation, the client device 102 receives a TV signal or some other type of streaming video signal or audio signal. The client device 102 then communicates at least a portion of the received signal to the TV 110 for display to the user 221. As described above, the second screen client device 120 is configured to detect the media content playing on the first device (e.g. TV 110) and enable sharing of content-synchronized ratings associated with the media content playing on the TV 110. Similar arrangements may be found within residential locations 202, 203, 204, 205 and 206, in which other users (not shown) similarly equipped can provide and share ratings about the same media content. Moreover, while residential locations have been used in this particular example, those skilled in the art will appreciate from the present disclosure that client devices and the like can be located in any type of location, including commercial, residential and public locations. More specific details pertaining to how content-synchronized ratings are shared amongst users are described below with reference to the remaining drawings and continued reference to FIGS. 1 and 2.

FIG. 3A is a block diagram of a configuration of the ratings server 130 according to some implementations. In some implementations, the ratings server 130 includes one or more processing units (CPU's) 302, one or more network or other communications interfaces 308, memory 306, and one or more communication buses 304 for interconnecting these and various other components. The communication buses 304 optionally include circuitry (sometimes called a chipset) that interconnects and controls communications between system components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302. Memory 306, including the non-volatile and volatile memory device(s) within memory 306, comprises a non-transitory computer readable storage medium. In some implementations, memory 306 or the non-transitory computer readable storage medium of memory 306 stores the following programs, modules and data structures, or a subset thereof including an operation system 316, a network communication module 318, a content information extract module 131, a content database 136, a fingerprint database 132, a user database 137, and applications 138.

The operating system 316 includes procedures for handling various basic system services and for performing hardware dependent tasks.

The network communication module 318 facilitates communication with other devices via the one or more communication network interfaces 308 (wired or wireless) and one or more communication networks, such as the Internet, other wide area networks, local area networks, metropolitan area networks, and so on. With further reference to FIG. 1, the network communication module 318 may be incorporated into the front end server 134.

The content database 136 includes content files 328 and/or links to content files 230. In some implementations, the content database 136 stores advertisements, videos, images, music, web pages, email messages, SMS messages, a content feeds, advertisements, coupons, playlists, XML documents and any combination thereof. In some implementations, the content database 1376 includes links to advertisements, videos, images, music, web pages, email messages, SMS messages, content feeds, advertisements, coupons, playlists, XML documents and any combination thereof. Content files 328 are discussed in more detail in the discussion of FIG. 3B.

The user database 137 includes user data 340 for one or more users. In some implementations, the user data for a respective user 340-1 includes a user identifier 342, user characteristics 344 and user account information 345. The user identifier 342 identifies a user. For example, the user identifier 342 can be an IP address associated with a client device 102 or an alphanumeric value chosen by the user or assigned by the server that uniquely identifies the user. The user characteristics 344 include the characteristics of the respective user.

The fingerprint database 132 stores one or more content fingerprints 332. A fingerprint 332 includes a name 334, fingerprint audio information 336 and/or fingerprint video information 338, and a list of associated files 339. The name 334 identifies the respective content fingerprint 332. For example, the name 334 could include the name of an associated television program, movie, or advertisement. In some implementations, the fingerprint audio information 336 includes a fingerprint or other compressed representation of a clip (such as several seconds, minutes, or hours) of the audio content of a video stream or an audio stream. In some implementations, the fingerprint video information 338 includes a fingerprint of a clip (such as several seconds, minutes, or hours) of a video stream. Fingerprints 332 in the fingerprint database 132 are periodically updated.

The content information extraction module 131 receives content information 164 from the second screen client device 120, generates a set of instructions 132 and sends a set of instructions 132 to the second screen client device 120. Additionally and/or alternatively, the ratings server 130 can receive content information 164 from the client device 102. The content information extraction module 131 includes an instruction generation module 320 and a fingerprint matching module 222. In some implementations, the content information extraction module 131 also includes a fingerprint generation module 321, which generates fingerprints from the content information 164 or other media content saved by the server 130.

The fingerprint matching module 322 matches at least a portion of the content information 164 (or a fingerprint of the content information 164 generated by the fingerprint generation module) to a fingerprint 332 in the fingerprint database 132. The matched fingerprint 342 is sent to the instruction generation module 320. The fingerprint matching module 322 includes content information 164 received from at least one of the client device 102 and the second screen client device 120. The content information 164 includes audio information 324, video information 326 and a user identifier 329. The user identifier 329 identifiers a user associated with at least one of the client device 102 and the second screen client device 120. For example, the user identifier 329 can be an IP address associated with a client device 102 (or 120) or an alphanumeric value chosen by the user or assigned by the server that uniquely identifies the user. In some implementations, the content audio information 324 includes a clip (such as several seconds, minutes, or hours) of a video stream or audio stream that was presented on the client device 102. In some implementations, the content video information 326 includes a clip (such as several seconds, minutes, or hours) of a video stream that was played on the client device 102.

The instruction generation module 320 generates a set of instructions 332 based on the matched fingerprint 342. In some implementations, the instruction generation module 320 generates the set of instructions 332 based on information associated with the matched fingerprint 342 and the user data 340 corresponding to the user identifier 329. In some implementations, the instruction generation module 320 determines one or more applications 138 associated with the matched fingerprint 342 to send to the second screen client device 120. In some implementations, the instruction generation module 320 determines one or more content files 328 based on the matched fingerprint 342 and sends the determined content files 328 to the second screen client device 320.

In some implementations, the set of instructions 332 includes instructions to execute and/or display one or more applications on the second screen client device 120. For example, when executed by the second screen client device 120, the set of instructions 332 may cause the second screen client device 120 to display an application that was minimized or running as a background process, or the set of instructions 132 may cause the second screen client device 120 to execute the application. In some implementations, the set of instructions 332 include instructions that cause the second screen client device 120 to download one or more content files 328 from the server system 106.

The applications 138 include one or more applications that can be executed on the second screen client device 120. In some implementations, the applications include a media application, a feed reader application, a browser application, an advertisement application, a coupon book application and a custom application.

Each of the above identified elements may be stored in one or more of the previously mentioned memory devices, and each of the modules or programs corresponds to a set of instructions for performing a function described above. The set of instructions can be executed by one or more processors (e.g., the CPUs 302). The above identified modules or programs (i.e., trigger module 118) need not be implemented as separate software programs, procedures or modules, and thus various subsets of these modules may be combined or otherwise re-arranged in various implementations. In some implementations, memory 306 may store a subset of the modules and data structures identified above. Furthermore, memory 306 may store additional modules and data structures not described above.

Although FIG. 3A shows a rating server, FIG. 3A is intended more as functional description of the various features which may be present in a set of servers than as a structural schematic of the implementations described herein. In practice, and as recognized by those of ordinary skill in the art, items shown separately could be combined and some items could be separated. For example, some items (e.g., operating system 316 and network communication module 318) shown separately in FIG. 3A could be implemented on single servers and single items could be implemented by one or more servers. The actual number of servers used to implement the ratings server 130 and how features are allocated among them will vary from one implementation to another, and may depend in part on the amount of data traffic that the system must handle during peak usage periods as well as during average usage periods.

FIG. 3B is a block diagram of an example of content file data structures 328 stored in the content database 136, according to some implementations. A respective content file 328 includes meta data 346 and content 354. The meta data 346 for a respective content file 328 includes a content file identifier (file ID) 348, a content file type 250, targeted information 352, one or more associated fingerprints 353, metrics 355 and optionally, additional information. In some implementations, the file ID 348 uniquely identifies a respective content file 328. In other implementations, the file ID 348 uniquely identifies a respective content file 328 in a directory (e.g., a file director) or other collection of documents within the content database 136. The file type 350 identifies the type of the content file 328. For example, the file type 350 for a respective content file 328 in the content database 136 indicates that the respective content file 328 is a video file, an image file, a music file, a web page, an email message, an SMS message, a content feed, an advertisement, a coupon, a playlist and an XML document. The associated fingerprint 353 identifies one or more fingerprints in the fingerprint database 136 that are associated with the respective content file 328. In some implementations, the associated fingerprints for a respective content file are determined by a broadcaster or creator of the document. In some implementations, the associated fingerprints are extracted by a module associated with the ratings server 130 or a third party device/system. The targeted information 352 data represents the document provider's targeted information for the content file 328. The target information data represents a population that the document provider wishes to target with the file. The metrics 355 provide a measure of the importance of a file 328. In some implementations, the metrics 355 are set by the creator or owner of the document. In some implementations, the metrics 355 represent popularity, number of views or a bid. In some implementations, multiple parties associate files with a content fingerprint and each party places a bid to have their file displayed when content corresponding to the content fingerprint is detected. In some implementations, the metrics 355 include a click through-rate. For example, a webpage may be associated with a content fingerprint.

FIG. 4A is a block diagram of a configuration of the client device 102 according to some implementations. The client device 102 typically includes one or more processing units (CPU's) 402, one or more network or other communications interfaces 408, memory 406, and one or more communication buses 404, for interconnecting these and various other components. The communication buses 404 optionally include circuitry (sometimes called a chipset) that interconnects and controls communications between system components. The client device 102 may also include a user interface comprising a display device 413 and a keyboard and/or mouse (or other pointing device) 414. Memory 406 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 406 may optionally include one or more storage devices remotely located from the CPU(s) 402. Memory 406, or alternatively the non-volatile memory device(s) within memory 406, comprises a non-transitory computer readable storage medium. In some implementations, memory 406 or the computer readable storage medium of memory 306 store the following programs, modules and data structures, or a subset thereof including operation system 416, network communication module 418, a video module 426 and data 420.

The client device 102 includes a video input/output 430 for receiving and outputting video streams. In some implementations, the video input/output 430 is configured to receive video streams from radio transmissions, satellite transmissions and cable lines. In some implementations the video input/output 430 is connected to a set top box. In some implementations, the video input/output 430 is connected to a satellite dish. In some implementations, the video input/output 430 is connected to an antenna.

In some implementations, the client device 102 includes a television tuner 432 for receiving video streams or TV signals.

The operating system 416 includes procedures for handling various basic system services and for performing hardware dependent tasks.

The network communication module 418 facilitates communication with other devices via the one or more communication network interfaces 404 (wired or wireless) and one or more communication networks, such as the Internet, other wide area networks, local area networks, metropolitan area networks, and so on.

The data 420 includes video streams 161.

The video module 426 derives content information 164 from a video stream 161. In some implementations, the content information 161 includes audio information 324, video information 326, a user identifier 329 or any combination thereof. The user identifier 329 identifies a user of the client device 102. For example, the user identifier 329 can be an IP address associated with a client device 102 or an alphanumeric value chosen by the user or assigned by the server that uniquely identifies the user. In some implementations, the audio information 324 includes a clip (such as several seconds, minutes, or hours) of a video stream or audio stream. In some implementations, the video information 326 may include a clip (such as several seconds, minutes, or hours) of a video stream. In some implementations, the video information 326 and audio information 324 are derived from a video stream 161 that is playing or was played on the client 102. The video module 426 may generate several sets of content information 164 for a respective video stream 161.

Each of the above identified elements may be stored in one or more of the previously mentioned memory devices, and each of the modules or programs corresponds to a set of instructions for performing a function described above. The set of instructions can be executed by one or more processors (e.g., the CPUs 402). The above identified modules or programs (i.e., sets of instructions) need not be implemented as separate software programs, procedures or modules, and thus various subsets of these modules may be combined or otherwise re-arranged in various implementations. In some implementations, memory 306 may store a subset of the modules and data structures identified above. Furthermore, memory 406 may store additional modules and data structures not described above.

Although FIG. 4A shows a client device, FIG. 4A is intended more as functional description of the various features which may be present in a client device than as a structural schematic of the implementations described herein. In practice, and as recognized by those of ordinary skill in the art, items shown separately could be combined and some items could be separated.

FIG. 4B is a block diagram of a configuration of a second screen client device 120, in accordance with some implementations. The second screen client device 120 typically includes one or more processing units (CPU's) 121, one or more network or other communications interfaces 445, memory 122, and one or more communication buses 441, for interconnecting these and various other components. The communication buses 441 optionally include circuitry (sometimes called a chipset) that interconnects and controls communications between system components. The second screen client device 120 may also include a user interface comprising a display device 128, speakers 129 and a keyboard and/or mouse (or other pointing device) 444. Memory 122 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 122 may optionally include one or more storage devices remotely located from the CPU(s) 121. Memory 122, or alternatively the non-volatile memory device(s) within memory 122, comprises a non-transitory computer readable storage medium. In some implementations, memory 122 or the computer readable storage medium of memory 122 store the following programs, modules and data structures, or a subset thereof including operation system 447, network communication module 448, graphics module 449, a instruction module 124 and applications 125.

The operating system 447 includes procedures for handling various basic system services and for performing hardware dependent tasks.

The network communication module 448 facilitates communication with other devices via the one or more communication network interfaces 445 (wired or wireless) and one or more communication networks, such as the Internet, other wide area networks, local area networks, metropolitan area networks, and so on.

The instruction module 124 receives a set of instructions 432 and optionally content files 428 and/or links to content files 430. The instruction module 124 executes the set of instructions 432. In some implementations, the instruction module 124 executes an application 125 in accordance with the set of instructions 432. For example, in some implementations, the instruction module 124 executes a web browser 455-1 which displays a web page in accordance with the set of instructions 432. In some implementations, the instruction module 124 displays the contents of one or more content files 428. For example, in some implementations, the instruction module 124 may display an advertisement. In some implementations, the instruction module 124 retrieves one or more content files referenced in the links 430.

The second screen client device 120 includes one or more applications 125. In some implementations, the applications 125 include a browser application 455-1, a media application 455-2, a coupon book application 455-3, a feed reader application 455-4, an advertisement application 455-5, custom applications 455-6 and fingerprint module 455-7. The browser application 455-1 displays web pages. The media application 455-2 plays videos and music, displays images and manages playlists 456. The feed reader application 355-4 displays content feeds 458. The coupon book application 455-3 stores and retrieves coupons 457. The advertisement application 455-5 displays advertisements. The custom applications 455-6 display information from a website in a format that is easily viewable on a mobile device. The applications 125 are not limited to the applications discussed above.

Each of the above identified elements may be stored in one or more of the previously mentioned memory devices, and each of the modules or programs corresponds to a set of instructions for performing a function described above. The set of instructions can be executed by one or more processors (e.g., the CPUs 121). The above identified modules or programs (i.e., sets of instructions) need not be implemented as separate software programs, procedures or modules, and thus various subsets of these modules may be combined or otherwise re-arranged in various implementations. In some implementations, memory 306 may store a subset of the modules and data structures identified above. Furthermore, memory 306 may store additional modules and data structures not described above.

Although FIG. 4B shows a client device, FIG. 4B is intended more as functional description of the various features which may be present in a client device than as a structural schematic of the implementations described herein. In practice, and as recognized by those of ordinary skill in the art, items shown separately could be combined and some items could be separated.

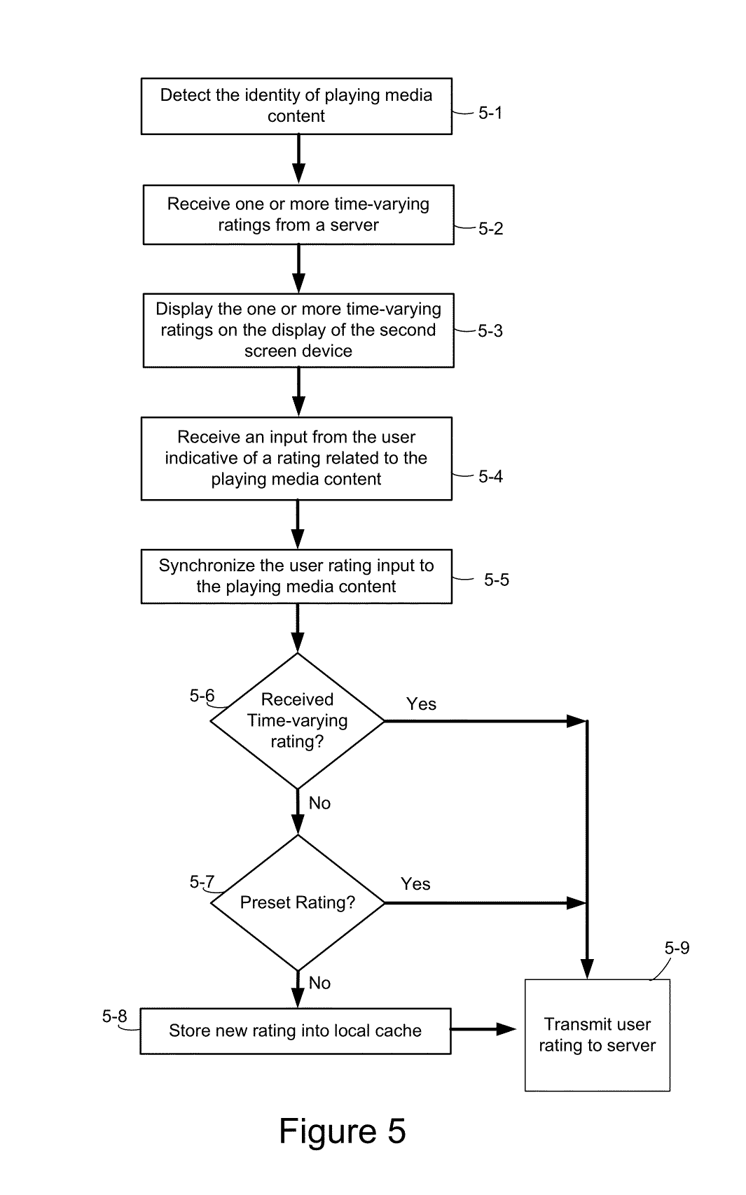

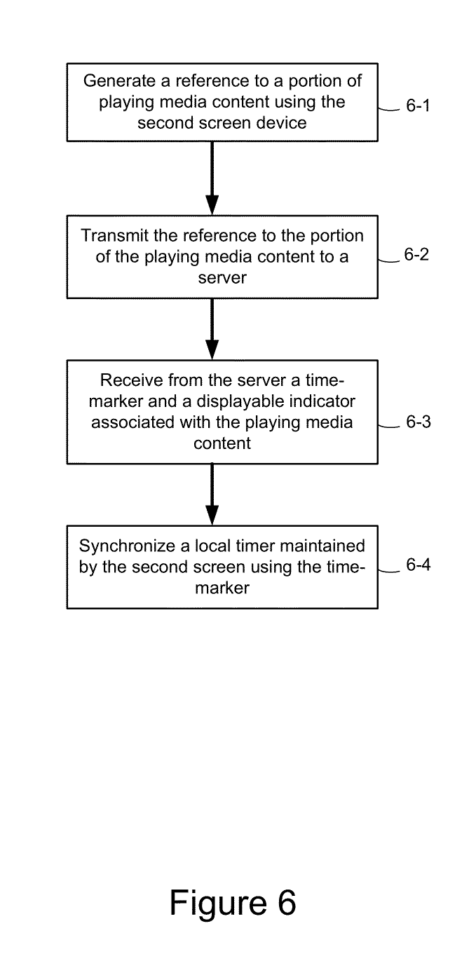

FIG. 5 is a flowchart representation of a method according to some implementations. In some implementations, the method is performed by a second screen device (e.g. second screen client device 120 of FIG. 1) or a similarly configured device. In some implementations, the method may also be performed on the same device playing the media content, such as a laptop, tablet computer, display monitor or a TV driven by a internet-enabled device (e.g. a Google TV device). As represented by block 5-1, the method includes the second screen device detecting the identity (i.e. by fingerprinting) of the media content playing on a first device, such as a television (e.g. TV 110). More specific examples of methods of detecting the identity of playing media content are described below with reference to FIGS. 6, 9 and 10. As represented by block 5-2, the method includes receiving one or more time-varying ratings from a ratings server. As represented by block 5-3, the method includes displaying the one or more time-varying ratings on the display of the second screen device or similarly configured device (which is possibly integrated with the. As represented by block 5-4, the method includes receiving an input from the user indicative of a rating related to the media content playing on the first device. As represented by block 5-5, the method includes synchronizing the user rating input to a time scale associated with the playing media content. A more detailed example of synchronizing the user input to the playing media content is described below with reference to FIG. 6.

As represented by block 5-6, the method includes determining whether or not the user rating input corresponds to one of the received time-varying ratings. In some implementations, the time-varying ratings correspond to ratings provided by other users for the same media content playing on the first device. For example, with further reference to FIG. 2, the time-varying rating correspond to rating provided by users at some of the locations 202, 203, 204, 205, 206. So, in other words, as represented by block 5-6, the method includes determining whether or not the user rating input corresponds to the user repeating and/or assenting to the rating provided by another user in the same or another location. If the user rating input corresponds to one of the received time-varying ratings (“Yes” path from block 5-6), as represented by block 5-9, the method includes transmitting the user rating to a ratings server. In some implementations, as described in further detail below, the user rating input is included in a data structure along with other information to allow the server analyze the rating individually and/or in combination with other ratings received from other users viewing the same media content. In some implementations, the user rating input may be matched to other ratings that are correlated with the user rating input within a particular range so that ratings are aggregated.

On the other hand, if the user rating input does not correspond to one of the received time-varying ratings (“No” path from block 5-6), as represented by block 5-7, the method includes determining whether or not the user rating input corresponds to a preset rating. In some implementations, a preset rating includes a rating that is available for selection by default on a number of second screen devices. Such ratings are provided because they have historically been or are expected to be frequently chosen by a significant number of users viewing a particular television program. For example, the ratings “Love it!” and “Hate it!” may be preset ratings in some implementations.

If the user rating input corresponds to a preset rating (“Yes” path from block 5-7), as represented by block 5-9, the method includes transmitting the user rating to a ratings server in a data structure. On the other hand, if the user rating input does not correspond to a preset rating (“No” path from block 5-7), as represented by block 5-8, the method includes determining that the user rating input is a new rating and storing the new rating in a local cache within the memory of the second screen device. Subsequently, as described above, as represented by block 5-9, method includes transmitting the user rating to the ratings server in a data structure.

FIG. 6 is a flowchart representation of a method according to some implementations. In some implementations, the method is performed by a second screen device (e.g. second screen client device 120 of FIG. 1) or a similarly configured device. In some implementations, the method may also be performed on the same device playing the media content, such as a laptop, tablet computer, display monitor or a TV driven by a internet-enabled device (e.g. a Google TV device). As represented by block 6-1, the method includes generating a reference to a portion of media content playing on a first device, such as a television. As described above, a reference may include, among other information, fingerprints of the stored audio content, the audio content itself, portions/snippets of the audio content, fingerprints of the portions of the audio content, an audio recording of the playing media content, a video recording of the playing media content, and/or characteristic extracted from one of an audio or video recording of the playing media content. As represented by block 6-2, the method includes transmitting the reference to the portion of the media content to a ratings server. As represented by block 6-3, the method includes receiving from the rating server a time-marker associated with the playing media content. In some implementations, the time-marker includes at least one of a value indicative of a time-offset between the start time of the media content and the portion thereof that was used to generate the transmitted reference, an absolute time value provided by a system clock maintained by the server and/or broadcast system, and a relative time value based on the a system clock time. As represented by block 6-4, the method includes synchronizing a local timer maintained by the second screen device using the received time-marker.

With continued reference to FIGS. 1 and 2, FIG. 7 is a schematic diagram including example screenshots of the TV 110 and the second screen client device 120 according to some implementations. The display 118 of the TV 110 displays a television program 502 about, for example, a sports team. While a TV is illustrated, those skilled in the art will appreciate from the present disclosure that the systems and methods disclosed herein may be used in combination with any media presentation device. The display 128 of the second screen client device 120 displays a user interface 520 of the application 125 for sharing content-synchronized ratings related to the television program 502.

As described above, while the television program 502 is playing on the TV 110, the second screen client device 120 acquires and/or generates a reference derived from the television program 502. The second screen client device 120 then transmits the reference to the ratings server 130. The ratings server 130 matches the content information to a content fingerprint in order to identify the television program 502. After identifying a content fingerprint that matches the content information, the ratings server 130 generates and/or retrieves a set of instructions and content associated with the television program 502, and transmits the set of instructions and the associated content to the second screen client device 120 for execution and display.

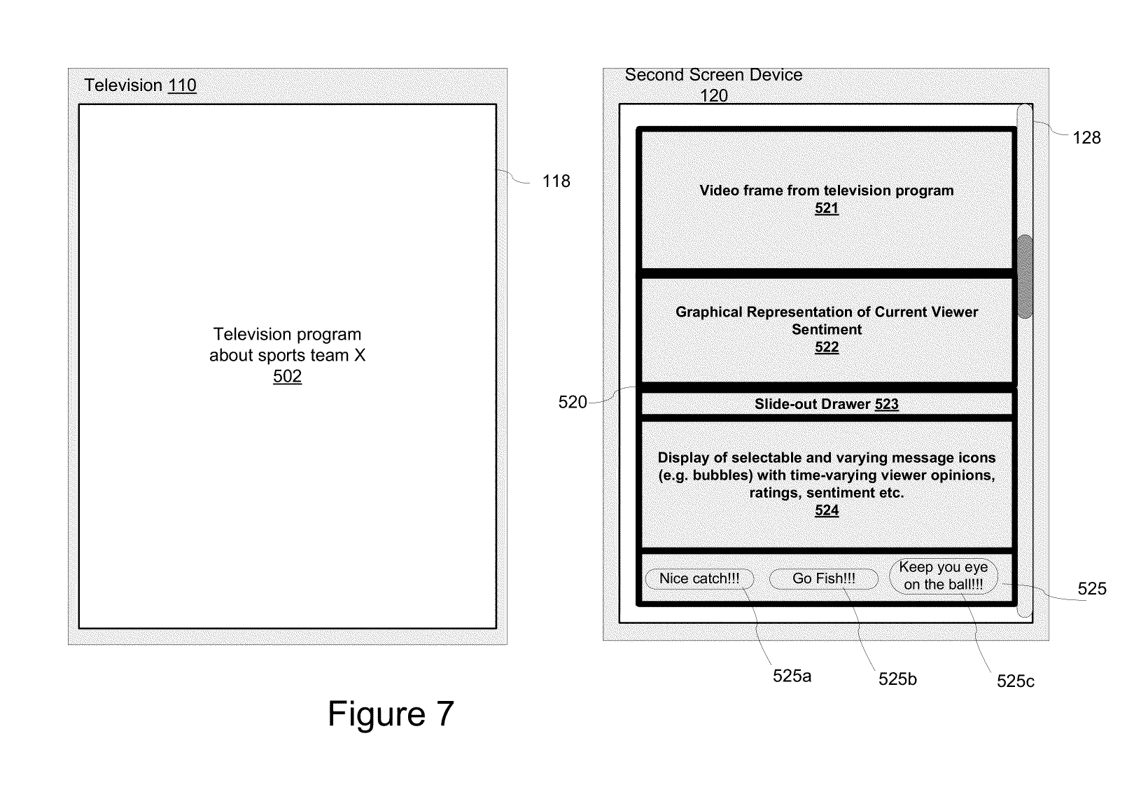

The second client device 120 executes the set of instructions, which includes instructions for displaying the received content associated with the television program 502 playing on the TV 110 within the user interface 520. In some implementations, the user interface 520 is configured to include five sections 521, 522, 523, 524, 525. While five sections are included in the example implementation described with reference to FIG. 7, those skilled in the art will appreciate that a fewer or a greater number of sections may be included in a user interface according to various other implementations.

In some implementations, the first section 521 is configured to display an image associated with the television program 502 in order to indicate to the user that the user interface 520 is displaying content specifically associated with the television program 502. For example, the first section 521 may display a recent frame from the television program, which may be updated periodically (e.g. every 5-10 secs). Additionally and/or alternatively, the first section 521 may display a logo associated with either the television program or the logo of a broadcast station (i.e. the logo of the television channel, station or network) that is airing the television program 502.

In some implementations, the second section 522 is configured to display a real-time chart graphically representing a summary of the content-synchronized ratings provided by users in various locations (e.g. locations 201, 202, 203, 204, 205, 206 in FIG. 2) viewing and commenting on the television program 502 as the television program 502 is airing. The chart generally summarizes the relative popularity of particular ratings and viewer sentiment as it relates to the television program 502 as a whole or portions thereof. In some embodiments, the chart is enabled to allow a user to derive metrics such as, for example, moving averages, comparisons of different ratings, etc.

In some implementations, the third section 523 is configured to display animations associated with current viewer sentiment. For example, if a majority of viewers provide ratings that indicate a negative sentiment towards the television program 502, a suitable animation reflecting that negative sentiment may be displayed. More specifically, for example, the animation may include a cartoon character sleeping if the viewers indicate that the television program 502 is boring. In yet another example, the animation may suddenly and without warning “pop” out, to catch the attention of a user, based on surges or significant changes in current viewer sentiment. For example, if the majority of users suddenly provide ratings that are indicative of a cheer or a show of support for a particular sports team in response to an event (e.g. scoring a goal during a game), an associated animation may pop up that reflects that surge in viewer sentiment. For example, the animation may include the mascot of the sports team dancing, wiggling and/or gyrating in a celebratory manner, and the mascot of the opposing sports team crying and vibrating. Those skilled in the art will appreciate from the present disclosure that the aforementioned specific examples of animations are merely illustrative and are not limiting.

In some implementations, the fourth section 524 is configured to display selectable time-varying suggested ratings, which are based on the ratings provided by other users during the course of the television program 502. In some implementations, each selectable time-varying suggested rating is displayed in an icon (e.g. a balloon, bubble, button, etc.) having varying respective visual characteristics that reflect the current popularity of the rating. For example, a particular selectable time-varying suggested rating that is increasingly being repeated by a number of users is displayed in a balloon that grows in size and moves to the foreground of the display. Additionally and/or alternatively, the color of the balloon may also become brighter. On the other hand, a particular selectable time-varying suggested rating that is waning in popularity is displayed in a balloon that is shrinking in size, moves to the background of the display, and eventually bursts after falling below a threshold level of popularity. In some implementations, the fourth section 524 is configured to allow a user to select one or more of the selectable time-varying suggested ratings by at least one of using a peripheral device, such as a mouse or keyboard, and/or by touching the display 128 if it is enabled as a touch-screen display.

In some implementations, the fifth section 525 is configured to display a number of selectable preset suggested ratings. In some implementations, each selectable preset suggested rating is displayed in an icon or button. For example, as illustrated in FIG. 7, the fifth section 525 includes three selectable preset suggested ratings buttons 525a, 525b, 525c. In some implementations, the selectable preset suggested ratings are ratings that have historically been or are expected to be frequently chosen by a significant number of users viewing the television program 502. For example, ratings such as, for example, “Love it!” and “Hate it!” may be preset ratings in some implementations. In some implementations, the selectable preset suggested ratings are larger and/or are more prominently displayed than the selectable time-varying suggested ratings. In some implementations, the selectable time-varying suggested ratings are larger and/or are more prominently displayed than the selectable preset suggested ratings. In some implementations, the fifth section 525 is configured to allow a user to select one or more of the selectable preset suggested ratings by at least one of using a peripheral device, such as a mouse or keyboard, and/or by touching the display 128 if it is enabled as a touch-screen display.

In some implementations, the user interface 520 may be configured to receive user ratings using a keyboard or virtual displayed keyboard on a touch-screen display. As such, a user can enter new ratings that are not present among the selectable preset suggested ratings and the selectable time-varying suggested ratings displayed.

In some implementations, the user interface 520 may be configured to determine the emphasis or “volume” with which a user selects or enters a rating. For example, the emphasis or volume may be determined based on how much pressure the user applies to a touch screen or other input device. For example, with specific reference to a touch screen, the ratio of touch area to the button area and/or duration of the touch might be used to provide an emphasis or volume indicator associated with a particular rating input from the user.

In some implementations, the application 125 is configured to generate a tuple or data structure for each rating input provided by a user. For example, in addition to a field for the rating input, the tuple or data structure includes, for example, fields for a stream identifier, a wall clock time, a content time, the emphasis or volume indicator and a location indicator. In some implementations, the stream identifier field includes a value that identifies the television program 502 playing on the TV 110. In some implementations, if consent is provided by a user, the wall clock time field includes a value indicative of the local time where the user is located (e.g. Pacific Standard Time in California, USA). In some implementations, if consent is provided by a user, content time field includes a value indicative of a time offset relative to the beginning of the television program 502. In some implementations, the location indicator field includes a value that is indicative of the user location (e.g. Palo Alto, Calif., USA).

While various non-limiting options have been described, those skilled in the art will appreciate from the present disclosure that various other options are also possible.

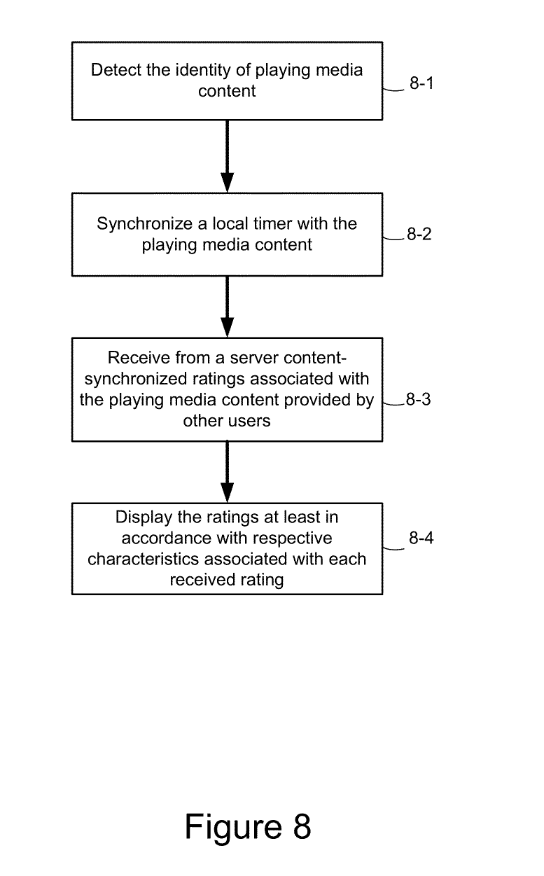

FIG. 8 is a flowchart representation of a method according to some implementations. In some implementations, the method is performed by a second screen device (e.g. second screen client device 120 of FIG. 1). As represented by block 8-1, the method includes detecting the identity of media content playing on a first device, such as a television (e.g. TV 110). As represented by block 8-2, the method includes synchronizing a local timer with the playing media content. As represented by block 8-3, the method includes receiving, from a server, content-synchronized ratings associated with the playing media content that were provided by other users. As represented by block 8-4, the method includes displaying the ratings at least in accordance with the respective characteristics associated with each received rating.

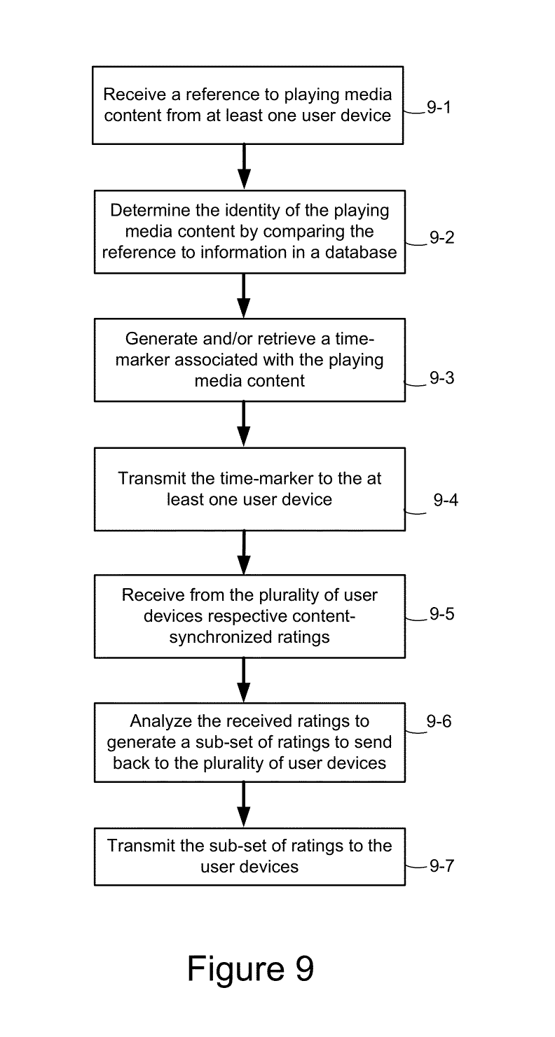

FIG. 9 is a flowchart representation of a method according to some implementations. In some implementations, the method is performed by a ratings server (e.g. ratings analysis module 139 of FIG. 1). As represented by block 9-1, the method includes receiving a reference to playing media content from at least one second screen device. As represented by block 9-2, the method includes determining the identity of the playing media content by comparing the reference to information in a fingerprint database. As represented by block 9-3, the method includes generating and/or retrieving a time-marker associated with the playing media content based on the determined identity. As represented by block 9-4, the method includes transmitted the time-marker to the at least one user device. As represented by block 9-5, the method includes receiving from the plurality of user devices respective content-synchronized ratings associated with the playing media content. As represented by block 9-6, the method includes analyzing the received ratings to generate a sub-set of ratings to send back to the plurality of user devices. As represented by block 9-7, the method includes transmitting the sub-set of ratings to the user devices.

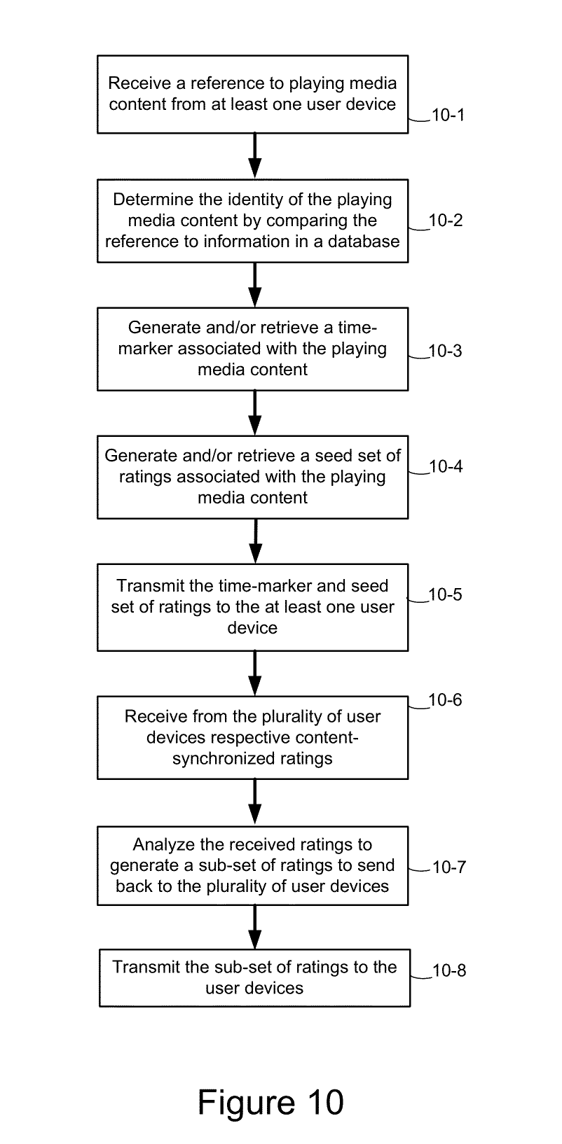

FIG. 10 is a flowchart representation of a method in accordance with some implementations. In some implementations, the method is performed by a ratings server (e.g. ratings analysis module 139 of FIG. 1). As represented by block 10-1, the method includes receiving a reference to playing media content from at least one second screen device. As represented by block 10-2, the method includes determining the identity of the playing media content by comparing the reference to information in a fingerprint database. As represented by block 10-3, the method includes generating and/or retrieving a time-marker associated with the playing media content based on the determined identity. As represented by block 10-4, the method includes generating and/or retrieving a seed set of ratings associated with the playing media content. In some implementations, the seed set of ratings includes ratings provided by users during previous episodes of a television program, expected ratings associated with the content of the television program and sponsored ratings purchased by advertisers. While various non-limiting options have been described, those skilled in the art will appreciate from the present disclosure that various other options are also possible.

As represented by block 10-5, the method includes transmitted the time-marker to the at least one user device. As represented by block 10-6, the method includes receiving from the plurality of user devices respective content-synchronized ratings associated with the playing media content. As represented by block 10-7, the method includes analyzing the received ratings to generate a sub-set of ratings to send back to the plurality of user devices. As represented by block 10-8, the method includes transmitting the sub-set of ratings to the user devices.

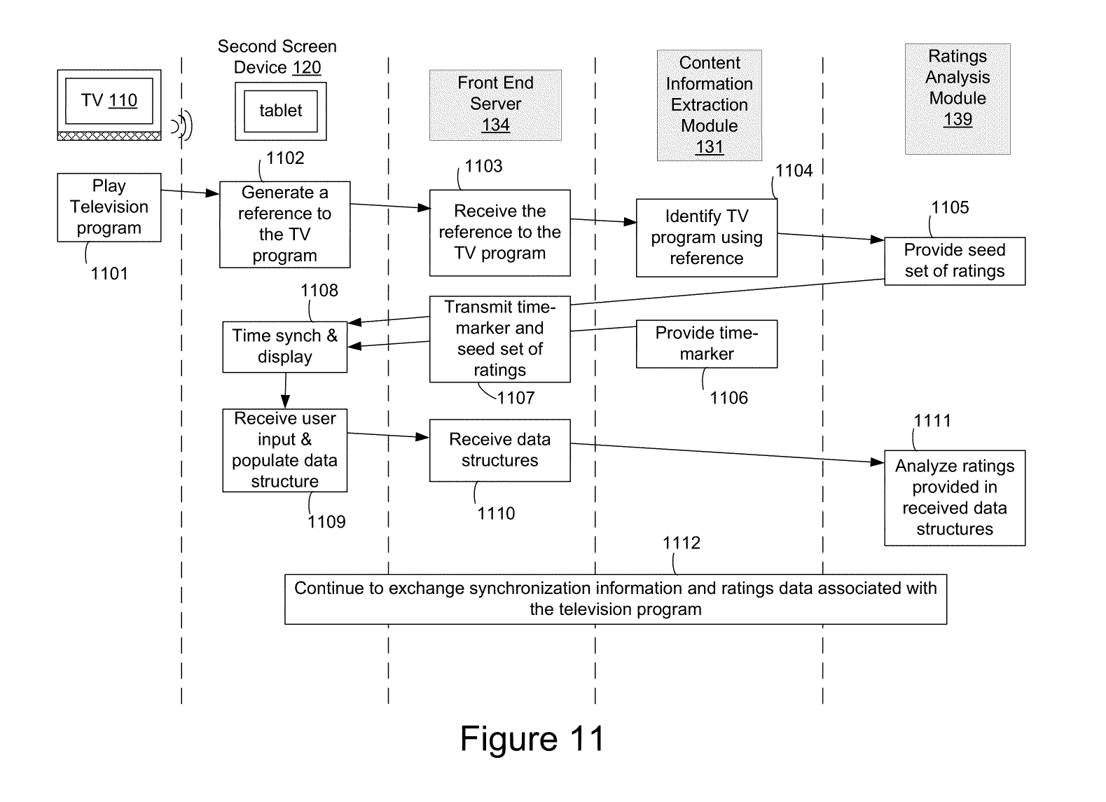

With further reference to FIG. 1, FIG. 11 is a simplified signaling diagram representing some example transmissions between components in the client-server environment 100. As represented by block 1101, the TV 110 plays a television program, such as, without limitation, a drama, a political debate, the nightly news, or a sporting event. Playing a television program includes displaying video on a display and outputting audio using speakers. As represented by block 1102, second screen client device 120 generates a reference to the TV program playing on the TV 110. To that end, in some implementations, the second screen client device 120 records at least one of audio or video output by the TV 110. In some implementations, the TV 110 and second screen client device 120 or the client device 102 and the second screen client device 120 share data connection that allows the second screen client device 120 to retrieve content associated with the playing television program that can be used to generate the reference. The second screen client device 120 then transmits the reference to the ratings server 130. As represented by block 1103, the front end server 134 receives the reference from the second screen client device 120. As represented by block 1104, content information extraction module 131 identifies the TV program by comparing information included in the reference against information in the fingerprint database until a match is found.

As represented by block 1105 the ratings analysis module 139 provides a seed set of ratings in response to the content information extraction module 131 identifying the TV program. As represented by block 1106, having determined the identity of the TV program, the content information extraction module 131 generates and/or retrieves a time-marker associated with the identified TV program.

As represented by block 1107, the front end server transmits a set of instructions, the time-marker and the seed set of ratings to the second screen client device 120. As represented by block 1108, the second screen device synchronizes a local time using the received time-marker and displays at least a portion of the seed set of ratings. In some implementations, the ratings are displayed in a graphical format and are individually selectable by the user 221 of the second screen client device 120. In some implementations, the ratings are displayed in a graphical format that represents how many other users previously selected each rating (if any), either in terms of percentage or number of selections per rating, etc.

As represented by block 1109, the second screen client device 120 receives a user input indicative of a ratings selection/input and populates a tuple or data structure that is then transmitted to the ratings server 130. As represented by block 1110 the front end server 134 receives the data structures from one or more second screen devices. As represented by block 1111 the ratings analysis module 139 analyzes the ratings included in the data structures.

As represented by block 1112 the components continue to exchange synchronization information and ratings data associated with the TV program for at least the duration of the TV program. The various second screen client devices that provide ratings data, in turn, receive updates including at least the results of the analysis of the ratings data.

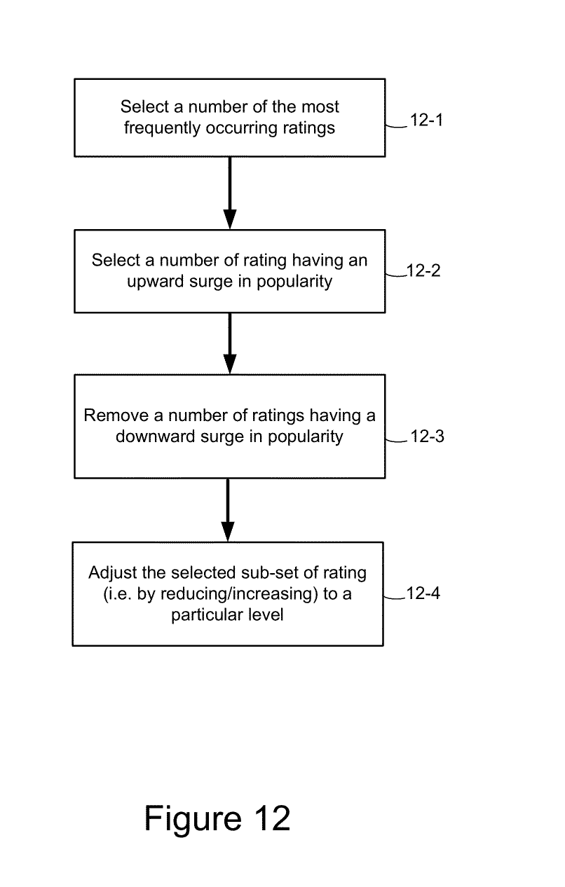

FIG. 12 is a flowchart representation of a method according to some implementations. In some implementations, the method is performed by a ratings server (e.g. ratings analysis module 139 of FIG. 1). As represented by block 12-1, the method includes selecting for a sub-set of ratings a number of the most frequently occurring ratings provided by various second screen devices. As represented by block 12-2, the method includes selecting for the sub-set a number of ratings having an upward surge in popularity. As represented by block 12-3, the method includes removing from the selected sub-set ratings determined to have a downward surge in popularity. In some implementations, determining whether there is a change in the popularity of a particular rating, such as an upward or downward surge, includes determining a difference in the number of users that input that rating in a previous time period with the number of users that input that same rating during the current time period. In some implementations, a surge, either up or down, is determined by comparing the difference to a threshold level. If the threshold is breached, a surge exists. As represented by block 12-4, the method includes adjusting the selected sub-set ratings to a particular number of ratings by reducing or increasing the number of rating included in the sub-set based at least on one other rule.

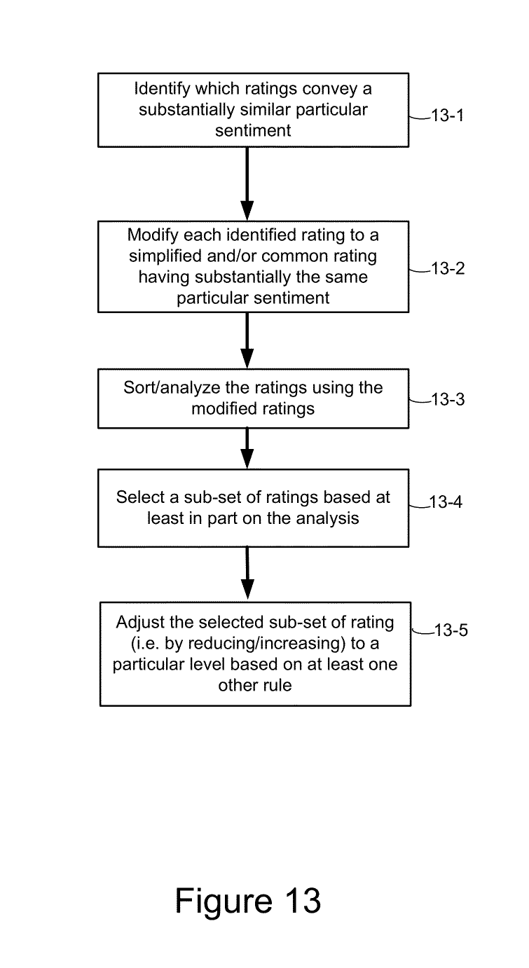

FIG. 13 is a flowchart representation of a method according to some implementations. In some implementations, the method is performed by a ratings server (e.g. ratings analysis module 139 of FIG. 1). As represented by block 13-1, the method includes identifying which ratings convey a substantially similar particular sentiment. As represented by block 13-2, the method includes modifying each of the identified ratings to a simplified and/or common rating having substantially the same particular sentiment. As represented by block 13-3, the method includes sorting the modified ratings. As represented by block 13-4, the method includes selecting a sub-set of ratings based at least in part on the sorting/analysis. As represented by block 13-5, the method includes adjusting the selected sub-set ratings to a particular number of ratings by reducing or increasing the number of ratings included in the sub-set based at least on one other rule. For example, the one other rule may specify that at least two unpopular ratings must be included in the sub-set.

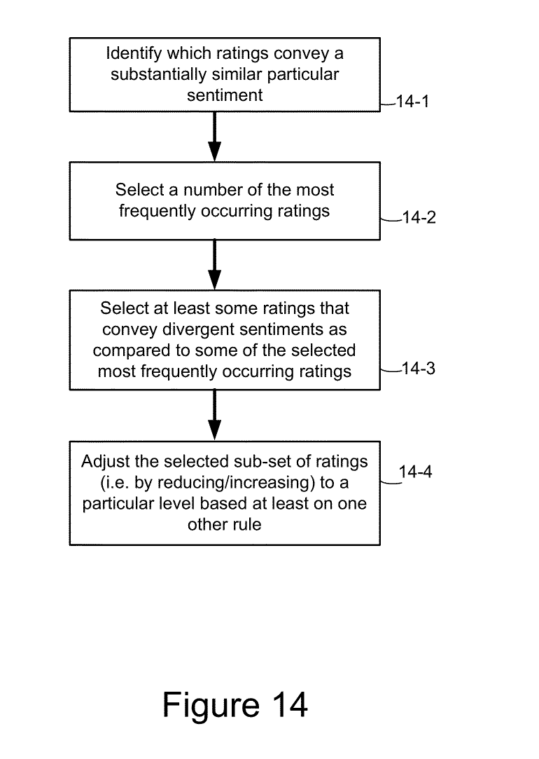

FIG. 14 is a flowchart representation of a method according to some implementations. In some implementations, the method is performed by a ratings server (e.g. ratings analysis module 139 of FIG. 1). As represented by block 14-1, the method includes identifying which ratings convey a substantially similar particular sentiment. As represented by block 14-2, the method includes selecting a number of the most frequently occurring ratings. As represented by block 14-3, the method includes selecting at least some ratings that convey divergent sentiments as compared to some of the selected most frequently occurring ratings. As represented by block 14-4, the method includes adjusting the selected sub-set of ratings to a particular level based at least on one other rule.

The foregoing description, for purpose of explanation, has been described with reference to specific implementations. The aspects described above may be implemented in a wide variety of forms, and thus, any specific structure and/or function described herein is merely illustrative. Moreover, the illustrative discussions above are not intended to be exhaustive or to limit the methods and systems to the precise forms disclosed. Many modifications and variations are possible in view of the above teachings. The implementations were chosen and described in order to best explain the principles of the methods and systems and their practical applications, to thereby enable others skilled in the art to best utilize the various implementations with various modifications as are suited to the particular use contemplated.

Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

Moreover, in the foregoing description, numerous specific details are set forth to provide a thorough understanding of the present implementation. However, it will be apparent to one of ordinary skill in the art that the methods described herein may be practiced without these particular details. In other instances, methods, procedures, components, and networks that are well known to those of ordinary skill in the art are not described in detail to avoid obscuring aspects of the present implementation.

It will also be understood that, although the terms “first,” “second,” etc. may be used herein to describe various features, these features are not limited by these terms. These terms are only used to distinguish one element from another. For example, a first device could be termed a second device, and, similarly, a second device could be termed a first device, without changing the meaning of the description, so long as all occurrences of the “first device” are renamed consistently and all occurrences of the “second device” are renamed consistently.

Moreover, the terminology used herein is for the purpose of describing particular implementations and is not intended to be limiting of the claims. As used in the description of the implementations and the claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method of sharing content-synchronized ratings related to playing media content on a first device including a processor, memory and a display, the method comprising:
detecting, using the first device, media content playing to a user;
receiving, at the first device from a second device, a first content-synchronized rating associated with the playing media content;
displaying on the display the first content-synchronized rating associated with the playing media content;
displaying on the display an interface operable to receive a user input indicative of a user rating associated with the playing media; and
communicating a data structure including the user rating to the second device.

2. The method of claim 1, wherein the playing media content is playing on a second device.

3. The method of claim 1, wherein detecting the media content playing to the user on the first device includes:
referencing a portion of the playing media content;
transmitting the reference to the portion of the media content to an information extraction module;
receiving from the information extraction module a time marker associated with the playing media content; and
synching a local timer with the time marker.

4. The method of claim 3, wherein the displayable indicator includes an image associated with the playing media content, a portion of the playing media content or a third party logo.

5. The method of claim 3, further comprising receiving a displayable indicator of the playing media content.

6. The method of claim 3, wherein referencing the portion of the playing media content includes recording a portion of the playing media content, wherein the recorded portion includes audio components or image components.

7. The method of claim 1, wherein the display includes a touch-screen display, and the method further comprises enabling user interaction with the touch-screen display to enter inputs indicative of user ratings.

8. The method of claim 1, wherein displaying the received first content-synchronized rating includes displaying at least one of a graphical representation of the first content-synchronized rating and a text representation of the first content-synchronized rating.

9. The method of claim 1, wherein the displayed interface includes a time-variant one-touch selectable rating, a time-invariant one-touch selectable rating or a keypad for entering custom ratings.

10. The method of claim 1, wherein a user input indicative of a user rating has a limited character length.

11. The method of claim 1, wherein a user input indicative of a user rating is at least one of a still or moving animation.

12. The method of claim 1, wherein the data structure also includes a content time associated with the playing media content, a tone indicator associated with the user rating, a location indicator or a media content identification.

13. A method of sharing content-synchronized ratings, related to media content, on a first device including a processor and a memory, the method comprising:
transmitting a time marker associated with the media content to a plurality of user devices;
receiving from the plurality of user devices respective content-synchronized ratings related to media content;
analyzing the content-synchronized ratings to generate a sub-set of ratings; and
transmitting the sub-set of ratings to at least one of the plurality of user devices.

14. The method of claim 13, further comprising:
receiving a reference to a portion of media content playing to a user;
identifying the media content playing to the user from the reference; and
retrieving or generating the time marker for the identified media content.

15. The method of claim 14, wherein the reference is a record portion of the media content.

16. The method of claim 15, wherein the reference is recorded using a user device separate from a respective device used to play the media content.

17. The method of claim 14, wherein identifying the media content includes comparing the reference to a database of media content identifiers.

18. The method of claim 13, wherein analyzing the content-synchronized ratings includes:
selecting a number of more frequently occurring ratings;
selecting a number of ratings having an upward surge in popularity as compared to a previous analysis; and
removing from the sub-set a number of ratings having a downward surge in popularity.

19. The method of claim 13, wherein analyzing the content-synchronized ratings includes:
identifying which ratings are closely related in terms of conveying a substantially similar sentiment;
modifying each of the ratings identified as conveying a substantially similar sentiment into a simplified rating conveying the same; and
resorting the ratings taking into account the modified ratings.

20. The method of claim 13, wherein analyzing the content-synchronized ratings includes:
identifying which ratings convey substantially divergent sentiments;
selecting a number of the more frequently occurring ratings; and
selecting a number of ratings that convey substantially divergent sentiments as compared to the selected number of more frequently occurring ratings.

21. The method of claim 13 further comprising transmitting a suggested set of selectable ratings associated with the media content to the plurality of user devices.

22. The method of claim 21, wherein the suggested set of selectable ratings includes ratings associated with related media content to the content playing to the users.

23. The method of claim 22, wherein the related media content and the playing media content comprise episodes of the same television program.

24. The method of claim 21, wherein at least one of the suggested set of selectable ratings associated with the media content is associated with an advertisement.

25. A non-transitory computer readable medium including instructions for sharing content-synchronized ratings related to playing media content on a first device including a processor, memory and a display, the instructions when executed by the processor cause the first device to:
detect, using the first device, media content playing to a user;
receive, at the first device from a second device, a first content-synchronized rating associated with the playing media content;
display on the display the first content-synchronized rating associated with the playing media content;
display on the display an interface operable to receive a user input indicative of a user rating associated with the playing media; and
communicate a data structure including the user rating to the second device.

26. A system for sharing content-synchronized ratings related to playing media content:
a first device including a processor, memory and a display, the memory including instructions that when executed by the processor cause the first device to:
detect, using the first device, media content playing to a user;
receive, at the first device from a second device, a first content-synchronized rating associated with the playing media content;
display on the display the first content-synchronized rating associated with the playing media content;
display on the display an interface operable to receive a user input indicative of a user rating associated with the playing media; and
communicate a data structure including the user rating to the second device.
